(19) United States
(12) Patent Application Publication
(10) Pub. No.: US 2021/0291567 A1
(43) Pub. Date: Sep. 23, 2021

(54) PRINT SPEED ADJUSTMENT BASED ON A CALCULATED THROUGHPUT

(71) Applicant: Hewlett-Packard Development Company, L.P., Spring, TX (US)

(72) Inventors: Elliott Michael Downing, Vancouver, WA (US); Robert Matthew Yraceburu, Vancouver, WA (US); Catrina Marcia Klossner, Vancouver, WA (US)

(73) Assignee: Hewlett-Packard Development Company, L.P., Spring, TX (US)

(21) Appl. No.: 17/256,744

(22) PCT Filed: Dec. 11, 2018
(86) PCT No.: PCT/US2018/064934

§ 371 Date: Dec. 29, 2020

(51) Int. Cl. B41J 13/00; B41J 11/00

(52) U.S. Cl. CPC B41J 13/0027; B41J 11/007; B41J 13/0018

(57) ABSTRACT

In an example of a method for adjusting a print speed, a base throughput of a printing device is determined for a page gap and a print speed for a current page being constant. A calculated throughput for a number of upcoming pages is determined based on extra time for speeding up the print speed. The print speed is adjusted based on the base throughput and the calculated throughput.

### BACKGROUND

Printing devices may apply a print substance, which can include printing agents or colorants, to a printed media sheet such as paper. A printing device may include a black print substance and/or color print substances. In some examples, printing devices output the printed media sheets at different print speeds. For instance, a printing device may print some printed media sheets at a slow print speeds and other printed media sheets at faster print speeds.

### BRIEF DESCRIPTION OF THE DRAWINGS

FIG. 1 is a simplified isometric view of an example of a printing device that may be used for adjusting print speeds;

FIG. 2 is a block diagram of an example of an apparatus that may be used in an example of a method for adjusting print speeds;

FIG. 3 is a flow diagram illustrating an example of a method for adjusting print speeds;

FIG. 4 is a flow diagram illustrating another example of a method for adjusting print speeds; and

FIG. 5 is a flow diagram illustrating yet another example of a method for adjusting print speeds.

Throughout the drawings, identical reference numbers designate similar, but not necessarily identical, elements. The figures are not necessarily to scale, and the size of some parts may be exaggerated to more clearly illustrate the example shown. Moreover the drawings provide examples and/or implementations consistent with the description; however, the description is not limited to the examples and/or implementations provided in the drawings.

### DETAILED DESCRIPTION

Printing devices—including printers, copiers, fax machines, multifunction devices including additional scanning, copying, and finishing functions, all-in-one devices, and pad printers to print images on three dimensional objects—apply a print substance, which can include printing agents or colorants, to a substrate. A substrate is a superset of print media, such as plain paper, and can include any suitable object or materials to which a print substance from a printing device is applied. For ease of explanation, a substrate is referred to herein as a “page.” Print substances, including printing agents and colorants, are a superset of inks and can include toner, liquid inks, or other suitable marking material that may or may not be mixed with fusing agents, detailing agents, or other materials and can be applied to the substrate. For ease of explanation, a print substance is referred to herein as “ink.”

This disclosure relates to a method to dynamically adjust print speeds on the basis of the ink level (e.g., densities) to increase a page's drying or stabilization time. The disclosure also relates to a method for determining if the overhead associated with changing print speeds is worth a delay associated with increasing the print speed.

In some examples, low-level ink pages involve less drying. These low-level ink pages may be printed at a high speed and may be referred to as a high speed page, a fast page or a faster page.

In some examples, high-level ink pages may involve more drying than the low-level ink pages. For the high-level ink pages, the print speed may be slow to provide more drying time. In some examples, a printing device may include a dryer to facilitate drying. The high-level ink pages with a low print speed may be referred to as a low speed page, a slow page or a slower page.

A page gap is the distance between consecutive printed pages. The page gap between a slower page and faster page may be minimized when the print speed is constant. Also, there is no risk of pages crashing into each other when the print speed is constant. However, in some circumstances, the throughput of the printing device may be increased by adjusting the print speed to a higher speed.

The disclosure provides examples to calculate the theoretical throughput at each upcoming page while accounting for the extra time (e.g., delay) associated with print speed changes. If the calculated throughput exceeds the base throughput, then a print speed increase is justified. Otherwise, the print speed for a faster page may be decreased to the current print speed to maintain the base throughput.

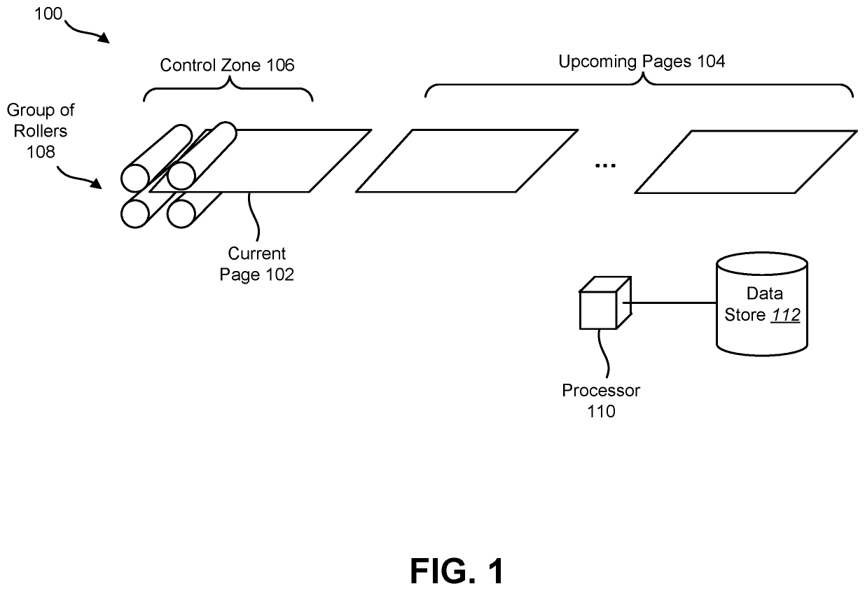

FIG. 1 is a simplified isometric view of an example of a printing device 100 that may be used for adjusting print speeds. The printing device 100 (e.g., a page wide inkjet printer) may adjust print speeds based on the ink levels on a page to increase that page's drying or stabilization time. The layout of page transport components may result in additional delays between pages to accommodate the requested speed changes. These additional delays (referred to herein as extra time) may reduce the throughput of the printing device 100. Because lower-ink pages may use less time for drying or stabilization, the lower-ink pages can print at slower speeds without negatively impacting the media quality. If a faster page (e.g., a lower-ink content page) is ready to print behind a slow page (e.g., higher-ink content page), the printing device 100 may determine if the overhead associated with changing print speeds is worth the extra time.

The printing device 100 may include a processor 110. In some examples, the processor 110 may be a computing device, a semiconductor-based microprocessor, a central processing unit (CPU), a graphics processing unit (GPU), field-programmable gate array (FPGA), an application-specific integrated circuit (ASIC), and/or other hardware device. The processor 110 may be connected to other components of the printing device 100 via communication lines (not shown).

The processor 110 may control motors and/or actuators (not shown) to control operations of the components of the printing device 100. For example, the processor 110 may control a motor (not shown) that determines the speed of a group of rollers 108 used to move a current page 102 through a control zone 106 (also referred to as a media path) of the printing device 100. The processor 110 may also control actuators that control the deposition of ink on the current page 102. The processor 110 may also control actuators that control the feeding of ink into the printhead(s) (not shown).

The processor 110 may communicate with a data store 112. The data store 112 may be a machine-readable storage medium. Machine-readable storage may be any electronic, magnetic, optical, or other physical storage device that stores executable instructions. Thus, a machine-readable storage medium may be, for example, Random-Access Memory (RAM), an Electrically Erasable Programmable Read-Only Memory (EEPROM), Magnetoresistive Random-Access Memory (MRAM), a storage drive, an optical disc, and the like. The data store 112 may be referred to as memory.

The data store 112 may include data pertaining to a current page 102 and upcoming pages 104. For example, the data store 112 may store data pertaining to a print queue. The data store 112 may also store data pertaining to print speeds associated with the current page 102 and upcoming pages 104. For example, each of the current page 102 and upcoming pages 104 may be associated with a print speed that is based on the page ink levels. In some examples, the current page 102 and upcoming pages 104 are included in the same document. In other examples, the current page 102 and upcoming pages 104 are included in separate documents.

As described below, machine-readable storage medium may also be encoded with executable instructions for adjusting the print speed for upcoming pages 104. For example, the data store 112 may include machine-readable instructions that cause the processor 110 to determine a base throughput of the printing device 100 for a page gap and a print speed for a current page 102 being constant. The data store 112 may also include machine-readable instructions that cause the processor 110 to determine a calculated throughput for a number of upcoming pages 104 based on extra time for speeding up the print speed. The data store 112 may further include machine-readable instructions that cause the processor 110 to adjust the print speed based on the base throughput and the calculated throughput.

In some examples, the printing device 100 may place ink down in a single pass at a particular print speed for a given page. In some cases, moisture from the ink may interact with the media substrate to produce a curled media in addition to creating a soft, soggy feel to the page. Altering the print speed may ensure denser ink pages remain constrained in the control zone 106 (also referred to as the media path) longer and/or receive more drying in devices that contain a dryer. The extra drying time associated with the slower print speed may improve or avoid the negative aspects mentioned.

On documents that have mixed ink levels, print speed can vary within a document. For example, a current page 102 may have a slower print speed than an upcoming page 104. For each print speed change, the printing device 100 may ensure that slow pages are far enough ahead of upcoming pages 104 to prevent a subsequent fast page from crashing into the slow page. Furthermore, the printing device 100 may ensure that faster pages will clear the control zone 106 before the speed drops for a following slow page.

In some examples, these conditions may result in larger gaps between pages (referred to as page gaps). Large page gaps may reduce the overall throughput of the printing device 100. For example, a document that has alternating pages of high ink and low ink may print the pages at 4 inches per second (ips) and 13 ips. While the throughput of 13 ips pages is very high, the throughput of this document may be less than running all of the pages at 4 ips if the extra time associated with changing the print speed is not considered.

In some examples, the print speed for a fast page that fits within a single control zone 106 may be slowed so a slower page can start sooner. However, a slower current page 102 cannot be sped up to accommodate a faster upcoming page 104 because this would affect the drying and stabilization time of the current page 102.

As seen by this discussion, the extra time associated with the transition from a slow page to a fast page may be unavoidable because the slow print speed is used to ensure media quality characteristics after printing. Conversely, a fast page may be printed at a slower speed without negatively impacting the media quality characteristics of the fast page. The printing device 100 may, thus, determine whether the extra time associated with the page gap to clear a slow page out of the control zone 106 is worth increasing the print speed of the next page.

The page gap is minimized when the print speed is constant. In this case, the control zone 106 (e.g., including a group of rollers 108) may not change speed. Therefore, there is no risk of pages crashing into each other as they pass through the control zone 106 for a constant print speed.

The processor 110 may determine the base throughput for printing at a constant print speed and with a constant page gap. For example, the process time (e.g., in seconds) of a single page may be determined by adding the length of the minimum page gap at the current print speed to the length of the page and dividing by the print speed. The base throughput may be expressed as pages-per-minute (ppm). The base throughput may be determined by dividing 60 by the process time. This is the base throughput that would be achieved if the current page 102 and upcoming pages 104 were printed at the current print speed.

In some circumstances, the extra time associated with an increased page gap resulting from a print speed increase may be recovered because the process time for pages with a new minimum gap at the higher print speed may take less time. The printing device 100 may calculate a theoretical throughput at each of the upcoming pages 104 while factoring in the extra time for speeding up the print speed and any speed changes within the upcoming pages 104. The processor 110 may determine a new page gap to transition from the slower print speed to the faster print speed to ensure that the faster page does not crash into the slower page in the control zone 106. The calculated process time for the faster speed may then be determined by adding the length of the new page gap and the length of the upcoming page 104 and dividing by the faster print speed. The calculated throughput may be determined by dividing 60 by the calculated process time.

If the calculated throughput equals or exceeds (i.e., is greater than) the base throughput, then the print speed increase is justified. In this case, the processor 110 may adjust the print speed for the next upcoming page 104. Otherwise, the print speed for a faster page is reduced to that of the current page 102 and the minimum gap may be used between pages to maintain the base throughput.

In some examples, the processor 110 may look ahead in a sequence of upcoming pages 104 until the processor 110 identifies an upcoming page 104 following the sequence of upcoming pages 104 with a print speed that is equal to or less than the print speed for the current page 102. The processor 110 may determine a calculated throughput for the sequence of upcoming pages 104. In other words, the upcoming pages 104 in the sequence may have print speeds that are greater than the current print speed of the current page 102. The processor 110 may determine the calculated throughput for the entire sequence of upcoming pages 104. If the calculated throughput of the sequence equals or exceeds the base throughput, then the print speed for the next upcoming page 104 may be increased. If the calculated throughput of the sequence is less than the base throughput, then the print speed for the next upcoming page 104 having a faster print speed may be reduced to the print speed for the current page 102.

In some examples, the printing device 100 (e.g., the processor 110) may track the lowest print speed in the upcoming pages 104 that is greater than the print speed for the current page 102. The printing device 100 may calculate the theoretical throughput if every page ran at that speed. The extra time for the print speed change may be based on this lowest print speed and any extra delays for print speed changes in the upcoming pages 104 are eliminated. It should be noted that the lowest print speed in the upcoming pages 104 may be greater than the current print speed. For example, the current print speed may be 5 ips, a number of upcoming pages 104 may have a print speed of 13 ips and other upcoming pages 104 may have a print speed of 7 ips. In this example, the processor 110 may determine the calculated throughput for all of the upcoming pages 104 using a print speed of 7 ips (e.g., the lowest print speed in the upcoming pages 104). If the calculated throughput of the sequence of upcoming pages 104 at the lowest print speed equals or exceeds the base throughput, then the print speed for the next upcoming page 104 may be increased to the lowest print speed. Each subsequent page may be calculated relative to the printing page ahead of itself.

The methods for determining print speeds may ensure that mixed print speed documents do not drop below the steady state throughput of the current print speed. This maximizes printer output across print jobs and limits the minimum throughput to that of the lowest print speed.

The printing device 100 may include additional components (not shown). Further, some of the components described herein may be removed and/or modified without departing from the scope of this disclosure. The printing device 100 as depicted in FIG. 1 may not be drawn to scale and may have a different size and/or configuration than shown. In another example, the printing device 100 may use any of a number of printing techniques. For example, the printing device 100 may be an inkjet printer, laser printer, etc.

In addition, the apparatuses disclosed herein to adjust the print speed may be external to the printing device 100. For instance, the apparatuses disclosed herein may be computing devices that are to determine print speed based on the base throughput and the calculated throughput. The disclosed apparatuses may communicate the determined print speed to the printing device 100.

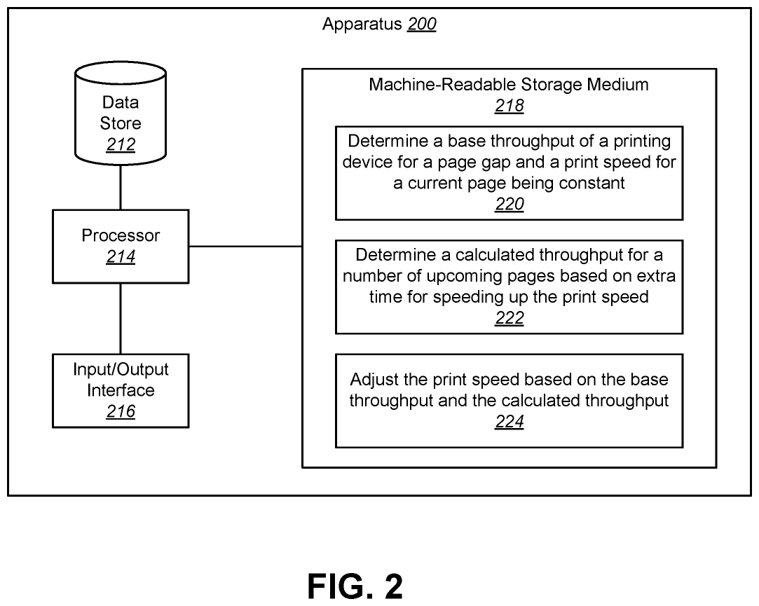

FIG. 2 is a block diagram of an example of an apparatus 200 that may be used in an example of a method for adjusting print speeds. The apparatus 200 may be a computing device, such as a personal computer, a server computer, a printer, a smartphone, a tablet computer, etc. In an example, the apparatus 200 may be equivalent to the processor 110 depicted in FIG. 1. The apparatus 200 may include a processor 214, a data store 212, an input/output interface 216, and a machine-readable storage medium 218. The apparatus 200 may further include additional components (not shown) and some of the components described herein may be removed and/or modified without departing from the scope of this disclosure.

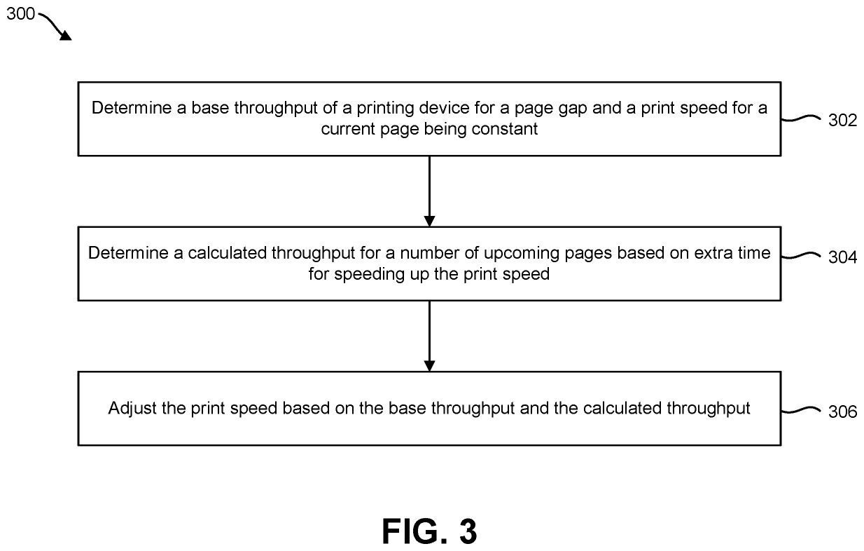

The processor 214 may be any of a central processing unit (CPU), a semiconductor-based microprocessor, GPU, FPGA, an application-specific integrated circuit (ASIC), and/or other hardware devices suitable for retrieval and execution of instructions stored in the machine-readable storage medium 218. The processor 214 may fetch, decode, and execute instructions, such as instructions 220-224 stored on the machine-readable storage medium 218, to control processes to determine 220 a base throughput of a printing device for a page gap and a print speed for a current page being constant; determine 222 a calculated throughput for a number of upcoming pages based on extra time for speeding up the print speed; and adjust 224 the print speed based on the base throughput and the calculated throughput. As an alternative or in addition to retrieving and executing instructions, the processor 214 may include an electronic circuit and/or electronic circuits that include electronic components for performing the functionalities of the instructions 220-224. These processes are described in detail below with respect to FIGS. 3-5.

The machine-readable storage medium 218 may be any electronic, magnetic, optical, or other physical storage device that contains or stores executable instructions. Thus, the machine-readable storage medium 218 may be, for example, RAM, EEPROM, a storage device, an optical disc, and the like. In some implementations, the machine-readable storage medium 218 may be a non-transitory machine-readable storage medium, where the term “non-transitory” does not encompass transitory propagating signals.

The apparatus 200 may also include a data store 212 on which the processor 214 may store information, such as information pertaining to the images to be printed. The data store 212 may be volatile and/or non-volatile memory, such as DRAM, EEPROM, MRAM, phase change RAM (PCRAM), memristor, flash memory, and the like.

The apparatus 200 may further include an input/output interface 216 through which the processor 214 may communicate with an external device(s) (not shown), for instance, to receive and store the information pertaining to the images to be printed. The input/output interface 216 may include hardware and/or machine-readable instructions to enable the processor 214 to communicate with the external device(s). The input/output interface 216 may enable a wired or wireless connection to the output device(s). The input/output interface 216 may further include a network interface card and/or may also include hardware and/or machine-readable instructions to enable the processor 214 to communicate with various input and/or output devices, such as a keyboard, a mouse, a display, another computing device, etc., through which a user may input instructions into the apparatus 200.

FIG. 3 is a flow diagram illustrating an example of a method 300 for adjusting print speeds. The method 300 for adjusting print speeds may be performed by, for example, the processor 110 and/or the apparatus 200. The apparatus may determine 302 a base throughput of a printing device 100 for a page gap and a print speed for a current page 102 being constant. For example, the apparatus may determine the number of pages that would be printed in a unit of time (e.g., minutes) assuming that the current print speed and page gap remain constant.

The apparatus may determine 304 a calculated throughput for a number of upcoming pages 104 based on extra time for speeding up the print speed. The number of upcoming pages 104 may be a sequence of pages immediately following the current page 102. The apparatus may determine 304 the calculated throughput for a sequence of upcoming pages 104 having print speeds greater than the print speed of the current page 102. In some examples, the apparatus may determine a new page gap to transition from the slower print speed to the faster print speed to ensure that a faster upcoming page 104 does not crash into the slower current page 102 in the control zone 106 of the printing device 100. The apparatus may then determine the calculated throughput for the upcoming pages 104 based on the new page gap and the higher print speeds of the upcoming pages 104.

The apparatus may adjust 306 the print speed based on the base throughput and the calculated throughput. If the calculated throughput equals or exceeds the base throughput, then the print speed may be increased. For example, the print speed of the next upcoming page 104 may be increased to a higher print speed after waiting for the new page gap to prevent the faster upcoming page 104 from crashing into the slower current page 102. If the calculated throughput is less than the base throughput, then the print speed for the faster upcoming page 104 may be reduced to the print speed for the current page 102. Additionally, if the calculated throughput is less than the base throughput, then the minimum page gap for the current page 102 may be applied to the upcoming page 104.

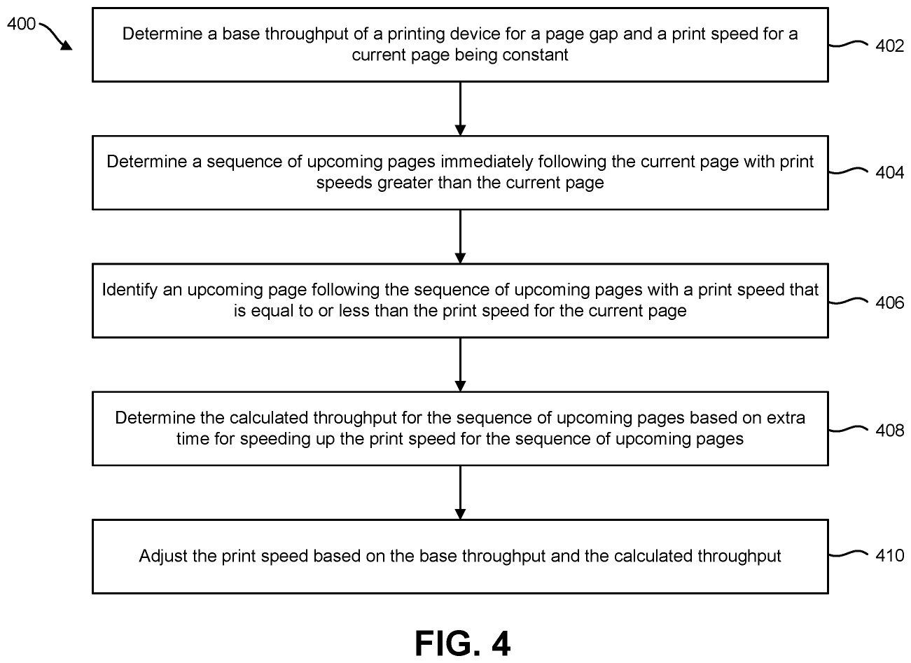

FIG. 4 is a flow diagram illustrating another example of a method 400 for adjusting print speeds. The method 400 for adjusting print speeds may be performed by, for example, the processor 110 and/or the apparatus 200. The apparatus may determine 402 a base throughput of a printing device 100 for a page gap and a print speed for a current page 102 being constant. This may be accomplished as described in connection with FIG. 3.

The apparatus may determine 404 a sequence of upcoming pages 104 immediately following the current page 102 with print speeds greater than the current page 102. The apparatus may determine that multiple upcoming pages 104 have faster print speeds than the current page 102. For example, the current print speed may be 5 ips. The apparatus may determine 404 a sequence of upcoming pages 104 that includes print speeds of 13 ips and 7 ips.

The apparatus may identify 406 an upcoming page 104 following the sequence of upcoming pages 104 with a print speed that is equal to or less than the print speed for the current page 102. For example, if the current print speed is 5 ips the apparatus may identify 406 an upcoming page 104 at the end of the sequence of upcoming pages 104 that has a print speed of 5 ips or less.

The apparatus may determine 408 the calculated throughput for the sequence of upcoming pages 104 based on extra time for speeding up the print speed for the sequence of upcoming pages 104. The extra time for speeding up the print speed may include an amount of time to permit a slower page (e.g., the current page 102) to clear a control zone 106 of the printing device 100 before increasing the print speed. The extra time for speeding up the print speed may also include a second amount of time to increase the print speed after the slower page has cleared the control zone 106 of the printing device 100 (e.g., to prevent the faster page from catching and crashing into the slower page after the control zone 106). In other words, the second amount of extra time may be the time that it takes the printing device 100 to reach the higher print speed. In some examples, a group of rollers 108 for the control zone 106 of the printing device 100 may be controlled by a single motor.

The apparatus may adjust 410 the print speed based on the base throughput and the calculated throughput. If the calculated throughput equals or exceeds the base throughput, then the print speed for a next upcoming page 104 may be increased. If the calculated throughput is less than the base throughput, then the print speed for the next upcoming page 104 having a faster print speed is reduced to the print speed for the current page 102.

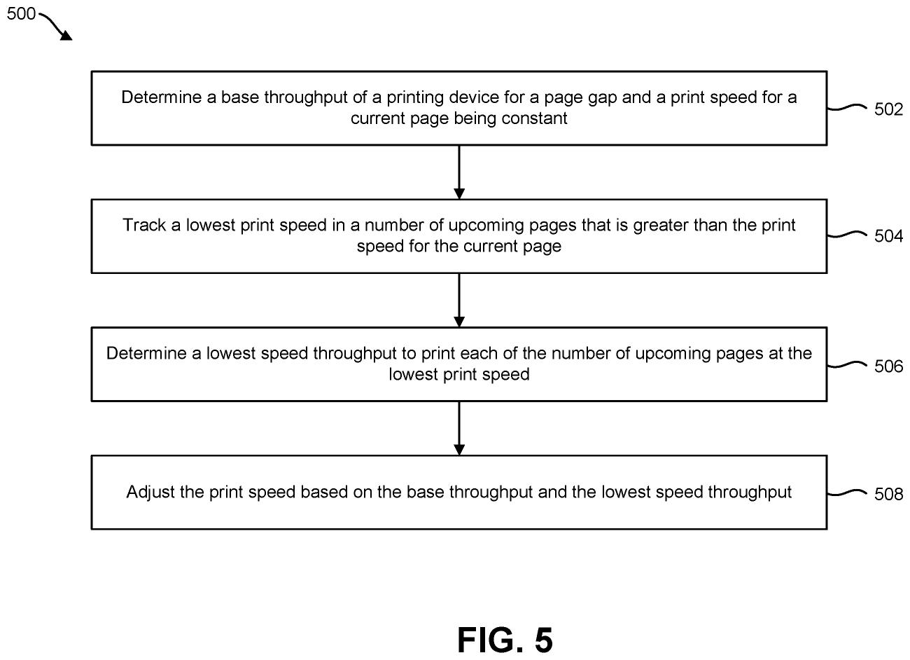

FIG. 5 is a flow diagram illustrating yet another example of a method 500 for adjusting print speeds. The method 500 for adjusting print speeds may be performed by, for example, the processor 110 and/or the apparatus 200. The apparatus may determine 502 a base throughput of a printing device 100 for a page gap and a print speed for a current page 102 being constant. This may be accomplished as described in connection with FIG. 3.

The apparatus may track 504 a lowest print speed in a number of upcoming pages 104 that is greater than the print speed for the current page 102. For example, the number of upcoming pages 104 may be a sequence of upcoming pages 104 immediately following the current page 102 that have print speeds greater than the current page 102. In some examples, the print speeds of the upcoming pages 104 may vary.

The apparatus may determine 506 a lowest speed throughput to print each of the number of upcoming pages at the lowest print speed. For example, the printing device 100 may calculate the theoretical throughput for the upcoming pages 104 if every upcoming page 104 ran at the lowest print speed of the upcoming pages 104. The calculated extra time resulting from the print speed change may be based on this lower print speed.

The apparatus may adjust 508 the print speed based on the base throughput and the lowest speed throughput. For example, if the calculated lowest speed throughput equals or exceeds the base throughput, then the print speed of a next upcoming page 104 may be changed to the lowest print speed of the upcoming pages 104. If the calculated lowest speed throughput is less than the base throughput, then the print speed for the next upcoming page 104 is reduced to the print speed for the current page 102.

1. A method for adjusting a print speed, comprising:
determining a base throughput of a printing device for a page gap and a print speed for a current page being constant;
determining a calculated throughput for a number of upcoming pages based on extra time for speeding up the print speed; and
adjusting the print speed based on the base throughput and the calculated throughput.

2. The method of claim 1, wherein if the calculated throughput equals or exceeds the base throughput, then the print speed is increased.

3. The method of claim 1, wherein if the calculated throughput is less than the base throughput, then a print speed for a faster upcoming page is reduced to the print speed for the current page.

4. The method of claim 1, wherein the number of upcoming pages comprise a sequence of pages immediately following the current page.

5. The method of claim 1, wherein determining the calculated throughput for the number of upcoming pages comprises determining the calculated throughput for a sequence of upcoming pages having print speeds greater than the print speed of the current page.

6. The method of claim 1, wherein determining the calculated throughput for the number of upcoming pages comprises determining a new page gap to transition from a slower print speed to a faster print speed to ensure that a faster upcoming page does not crash into the slower current page in a control zone of the printing device.

7. A computing device, comprising:
a memory;
a processor coupled to the memory, wherein the processor is to:
determine a base throughput of a printing device for a page gap and a print speed for a current page being constant;
determine a sequence of upcoming pages immediately following the current page with print speeds greater than the current page;
identify an upcoming page following the sequence of upcoming pages with a print speed that is equal to or less than the print speed for the current page; and
determine a calculated throughput for the sequence of upcoming pages based on extra time for speeding up the print speed for the sequence of upcoming pages; and
adjust the print speed based on the base throughput and the calculated throughput.

8. The computing device of claim 7, wherein if the calculated throughput equals or exceeds the base throughput, then the print speed for a next upcoming page is increased.

9. The computing device of claim 7, wherein if the calculated throughput is less than the base throughput, then a print speed for a next upcoming page having a faster print speed is reduced to the print speed for the current page.

10. The computing device of claim 7, wherein the extra time for speeding up the print speed comprises an amount of time to permit a slower page to clear a control zone of the printing device before increasing the print speed.

11. The computing device of claim 10, wherein the extra time for speeding up the print speed further comprises a second amount of time to increase the print speed after the slower page has cleared the control zone of the printing device.

12. The computing device of claim 10, wherein a group of rollers for the control zone of the printing device are controlled by a single motor.

13. A non-transitory machine-readable storage medium encoded with instructions executable by a processor, the machine-readable storage medium comprising:
instructions to determine a base throughput of a printing device for a page gap and a print speed for a current page being constant;
instructions to track a lowest print speed in a number of upcoming pages that is greater than the print speed for the current page;
instructions to determine a lowest speed throughput to print each of the number of upcoming pages at the lowest print speed; and
instructions to adjust the print speed based on the base throughput and the lowest speed throughput.

14. The machine-readable storage medium of claim 13, wherein if the lowest speed throughput equals or exceeds the base throughput, then the print speed of a next upcoming page is changed to the lowest print speed of the upcoming pages.

15. The machine-readable storage medium of claim 13, wherein if the lowest speed throughput is less than the base throughput, then the print speed for a next upcoming page is reduced to the print speed for the current page.
